(19) United States
(12) Patent Application Publication
(10) Pub. No.: US 2006/0253409 A1
(43) Pub. Date: Nov. 9, 2006

(54) Method, apparatus and computer program product providing local service discovery with browser search

(75) Inventors: Sami Ronkainen, Oulu (FI); Urpo Tuomela, Oulu (FI); Jonna Hakkila, Kalajoki (FI); Kirsi-Maria Hiltunen, Haukipudas (FI); Timo Perala, Helsinki (FI)

Correspondence Address: HARRINGTON & SMITH, LLP, 4 RESEARCH DRIVE, SHELTON, CT, 06484-6212, US

(73) Assignee: Nokia Corporation

(21) Appl. No.: 11/073,132

(22) Filed: Mar. 4, 2005

(51) Int. Cl. G06F 17/30

(52) U.S. Cl. 707/1

(57) ABSTRACT

Embodiments of the invention provide in part a method to conduct a search for information in a network. The method includes operating a user interface of a device to initiate the sending of a search request via a first channel; and indicating via the user interface selectively whether received information from at least one local source via a second channel is to be included as at least a part of the search. The embodiments of the invention further provide a node of a communication system, where the node includes a transmitter for communicating to a receiver of a device during mobility of the device, and where the node is operable for transmitting a predetermined search word set to the receiver for use by the device for composing a search request to a search engine.

### TECHNICAL FIELD

The presently preferred embodiments of this invention relate generally to search engines and related methods and, more specifically, relate to searching a network, such as the Internet, for contextually relevant information when using a mobile communications device.

### BACKGROUND

Currently some users of mobile communication devices or appliances use their devices to locate services that are local to them. For example, one may search for the closest restaurant, or for a location of an ATM machine, or for some other provider of a service or goods. At present, the only practical way to utilize digital appliances for searching is through the Internet, such as by using a World Wide Web (WWW) browser in a mobile communication device, with the expectation that at least some of the local services have WWW pages with contact information. As one example, one may go to the WWW pages of a certain national sporting goods chain in an attempt to find a local outlet.

In the future it is expected that commercial applications utilizing local radio connections will become common. For example, restaurants may have a low power RF, e.g., a Bluetooth™ or a Wireless Local Area Network (WLAN) “beacon” that pushes advertisements to the mobile devices of those who are willing to receive them.

However, the inventors have realized that if a number of future service providers utilize beacons having local radio connectivity to mobile devices, one problem that will arise is that many users may not want to receive these advertisements and will turn their reception off. Another problem is that since the concept of using local radio connections for service discovery is relatively new, there is no existing user interface metaphor that can readily be used in the search. Furthermore, it may be that an advertisement of a certain service provider does not produce sufficient information so that a user would actually know whether the particular service is of interest to the user. For example, a restaurant may advertise only its lunch fixed prices, while the user may actually be interested in the dinner menu-however, the desired information would not be available from the lunch price advertisement alone.

If a user performs a search in the WWW, the user may discover the more detailed and desired information about the restaurant. However, a problem that arises is that the user needs to know the restaurant (at least its name) beforehand so that the WWW search can be conducted.

Currently many people rely on information that they can visualize, for example in window advertising, or they may search for information in the Internet. Search engines in the WWW have started to provide limited local information, but thus far there has not been an automatic and easy way to discover the user's actual desired information. Reference with regard to the current state of, and problems with, local search technology may be had to, as an example, an article entitled “What Lies Ahead for Local Search Engine Technology”, Andy Beal, May 29, 2004, found at http://www.lilengine.com/search-engines/search-engines/0529041/page1.html (and subsequent pages).

Further, searching the Internet with generally available search engines in order to find contextually relevant information is not a trivial task. In the context of this description, contextually relevant information means information having relevance to the end user with respect to at least one of, as non-limiting examples, time, physical location and/or the end user's interest (temporally relevant, spatially relevant and/or interest relevant).

In order to locate contextually relevant information one needs to determine the appropriate search word(s). Too few, or too general, search words result in too many hits, i.e., references to information, which in turn makes the finding of the relevant information more difficult. In contrast, too many, and too limiting, search words lead to too few hits, whereby interesting and possibly important information may not be found among the search results. A ServiceGuide™ solution developed by the assignee of this invention provides a system solution whereby the system distributes, e.g., uniform resource locators (URLs) to the end users′mobile phone as a “bookmark”. The end user may then browse the Internet with the obtained bookmark. The bookmarks are intended to bear some relevance to the context where they are distributed.

### SUMMARY OF THE PREFERRED EMBODIMENTS

The foregoing and other problems are overcome, and other advantages are realized, in accordance with the presently preferred embodiments of this invention.

In a first aspect thereof this invention provides a method to conduct a search for information in a network, comprising operating a user interface of a device to initiate the sending of a search request via a first channel; and indicating via the user interface selectively whether received information from at least one local source via a second channel is to be included as at least a part of the search.

In a second aspect thereof this invention provides a device that comprises a user interface, a first interface to a first channel, a second interface to a second channel, and a controller coupled to the user interface and to the first and second interfaces. The controller is operable to conduct a search for information in a network in response to input received from the user interface by initiating the sending of a search request via the first channel and further in response to input received from said user interface to determine whether received information from at least one local source via the second channel is to be included as at least a part of the search.

In a further aspect thereof this invention provides a computer program product that comprises computer executable instructions stored in a computer readable medium for directing a computer embodied in a mobile device to conduct a search for information in a network by operations comprising operating a user interface of the device to initiate the sending of a search request via a first channel; and indicating via the user interface selectively whether received information from at least one local source via a second channel is to be included as at least a part of the search.

In a still further aspect thereof this invention provides a device that comprises user interface means, first interface means for coupling to a first wireless channel, second interface means for coupling to a second wireless channel, and control means coupled to the user interface means and to the first and second interface means for conducting a search for information in a network in response to input received from the user interface means. The control means is operable for initiating the sending of a search request via the first channel and, responsive to input received from the user interface means, to determine whether received information from at least one local source via the second channel is to be included as at least a part of the search.

In another aspect thereof this invention provides a node of a communication system that comprises a transmitter for communicating to a receiver of a device during mobility of the device, where the node is operable for transmitting a predetermined search word set to the receiver for use by the device for composing a search request to a search engine.

A still further aspect of this invention provides a method to conduct a search for information, and comprises receiving information from at least one local source via at least one local wireless beacon, and selectively using at least some of the received information when initiating a search via a wireless link to the Internet.

Another aspect of this invention pertains to a wireless device that comprises means for receiving information from at least one local source via at least one local wireless beacon; means for storing received information and means for selectively using at least some of the stored information to initiate a search via a wireless link to the Internet.

In yet another aspect thereof the embodiments of this invention provide a computer program that is embodied in a computer readable medium for execution by a processor of a mobile communication device. Execution of the computer program comprises operations of, when the mobile communication device is located in a certain geographical area, receiving a transmission from at least one local source via at least one local wireless beacon; storing information conveyed by the received transmission and formulating an Internet search request for transmission from the mobile communication device, where the Internet search request is formulated at least in part from the stored information so as to be pertinent to the certain geographical area. In certain embodiments of this invention formulating the Internet search request comprises receiving input from a user of the mobile communication device via a user interface of the mobile communication device, while in other embodiments of this invention formulating the Internet search request is performed by the processor without input from a user.

### BRIEF DESCRIPTION OF THE DRAWINGS

The foregoing and other aspects of the presently preferred embodiments of this invention are made more evident in the following Detailed Description of the Preferred Embodiments, when read in conjunction with the attached Drawing Figures, wherein:

FIG. 1 is a simplified block diagram an embodiment of a wireless communications system that is suitable for practicing this invention;

FIG. 2 depicts an exemplary and non-limiting embodiment of a distributed system for providing local, short range service discovery to the MS shown in FIG. 1;

FIG. 3 shows a displayed page of a search engine having, in accordance with embodiments of this invention, a local services user input area for enabling a user to selectively one of: request that local services be included in the search engine request, or that no local services be included in the search engine request, or that only local services be included in the search request;

FIG. 4 depicts operation of a local search algorithm shown in FIG. 1 in extracting local hits and WWW search hits for forming a displayed hit list;

FIG. 5 is a logic flow diagram that illustrates operations of pushing a search word set to the MS of FIG. 1, and the use of the search word set when launching a browser; and

FIG. 6 is a logic flow diagram that illustrates operations of performing a local search, obtaining local hits, presenting the local hits, and performing a WWW search using at least one local hit.

### DETAILED DESCRIPTION OF THE PREFERRED EMBODIMENTS

Presently preferred embodiments of this invention provide a local service discovery functionality that is preferably embedded in the search functionality of a WWW (or a Wireless Application Protocol (WAP)) browser; i.e., the same browser typically employed by a user. In one aspect the embodiments of the invention provide a user interface where the user selects whether to utilize local information in a search, and in another aspect there is provided an algorithm that operates with user selections entered via the user interface, and with local information (if selected for use) for improving the relevance of search results.

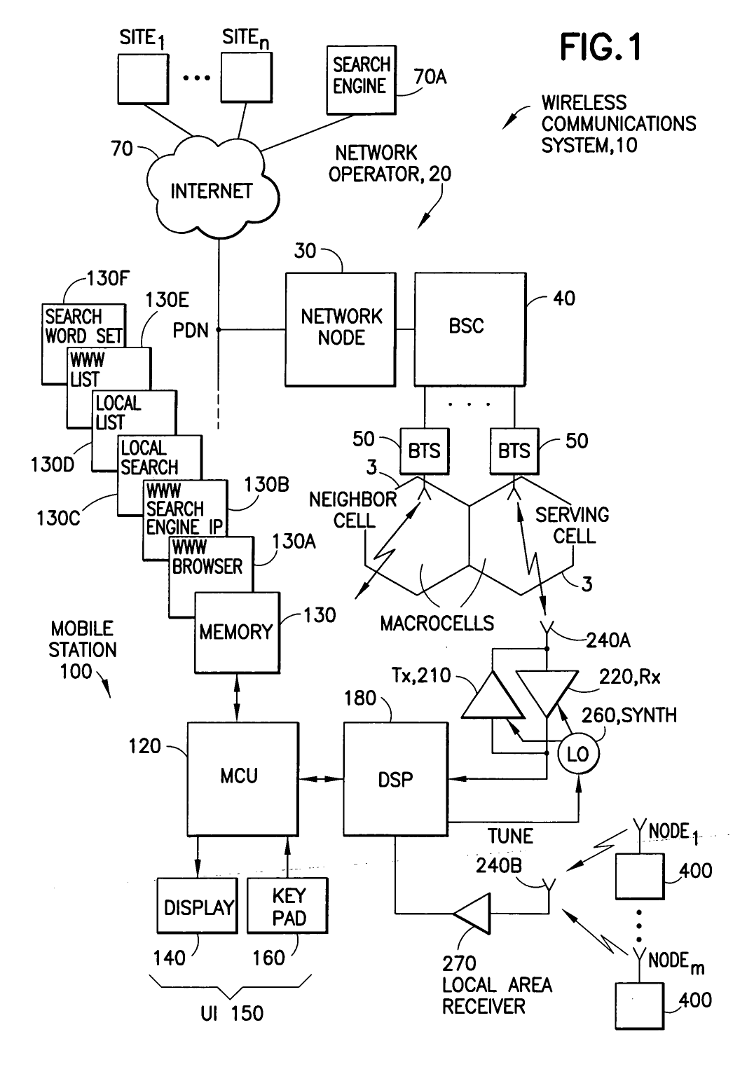

By way of introduction, and referring to FIG. 1, there is shown as a simplified block diagram an embodiment of a wireless communications system 10 that is suitable for practicing this invention. The wireless communications system 10 includes at least one mobile station (MS) 100. FIG. 1 also shows an exemplary network operator 20 having, for example, a node 30 for connecting to a telecommunications network, such as a Public Packet Data Network or PDN, at least one base station controller (BSC) 40 or equivalent apparatus, and a plurality of base transceiver stations (BTS) 50, also referred to as base stations (BSs), that transmit in a forward or downlink direction both physical and logical channels to the mobile station 100 in accordance with a predetermined air interface standard. A reverse or uplink communication path also exists from the mobile station 100 to the network operator, which conveys mobile originated access requests and traffic. A cell 3 is associated with each BTS 50, where one cell will at any given time be considered to be a serving cell, while an adjacent cell(s) will be considered to be a neighbor cell.

The air interface standard can conform to any suitable standard or protocol, and may enable both voice and data traffic, such as data traffic enabling Internet 70 access, browsing and web page downloads. Coupled to the Internet 70 are assumed to be a plurality of sites (Site₁ . . . Siteₙ) that may be of interest to the user, as well as a WWW search engine 70A.

The mobile station 100 typically includes a control unit or control logic, such as a microcontrol unit (MCU) 120 having an output coupled to an input of a display 140 and an input coupled to an output of a user entry device, such as a keyboard or keypad 160 (or a touch screen). The mobile station 100 may be a handheld radiotelephone, such as a cellular telephone or a personal communicator. The mobile station 100 could also be contained within a card or module that is connected during use to another device. For example, the mobile station 10 could be contained within a PCMCIA or similar type of card or module that is installed during use within a portable data processor, such as a laptop or notebook computer, or even a computer that is wearable by the user.

In general, the various embodiments of the MS 100 can include, but are not limited to, cellular telephones, personal digital assistants (PDAs), portable computers, image capture devices such as digital cameras, gaming devices, music storage and playback appliances, Internet appliances permitting Internet access and browsing, as well as portable units or terminals that incorporate combinations of such functions.

The MCU 120 is assumed to include or be coupled to some type of a memory 130, including a non-volatile memory for storing an operating program and other information, as well as a volatile memory for temporarily storing required data, scratchpad memory, received packet data, packet data to be transmitted, and the like. The operating program is assumed, for the purposes of this invention, to enable the MCU 120 to execute the software routines and protocols required to implement the methods in accordance with this invention, as well as to provide a suitable user interface (UI) 150, via display 140 and keypad 160, with a user. Although not shown, a microphone and speaker are typically provided for enabling the user to conduct voice calls in a conventional manner.

Associated with the memory 130 are assumed to be programs implementing a browser interface 130A enabling access to the WWW search engine 70A via the Internet 70, any required WWW search engine interface 130B, and the above-mentioned local search algorithm 130C that operates with the WWW search engine interface 130B, as will be described in further detail below. Associated with the local search algorithm 130C is a local search list 130D for recording information regarding advertisements and the like received through a local receiver 270, and a WWW list 130E for recording information regarding advertisements and the like received through the cellular receiver 220 from the search engine 70A, via the Internet 70. The local search list 130D maybe considered as a buffer for information received via the local receiver 270, while the WWW list 130E may be considered as a buffer for WWW page(s) received from the search engine 70A somewhere in the Internet 70.

The mobile station 100 also contains a wireless section that includes a digital signal processor (DSP) 180, or equivalent high speed processor or logic, as well as a wireless transceiver that includes a transmitter 200 and a receiver 220, both of which are coupled to an antenna 240A for communication with the network operator via a wireless link, such as a cellular communication link. At least one local oscillator, such as a frequency synthesizer (SYNTH) 260, is provided for tuning the transceiver. Data, such as digitized voice and packet data, are transmitted and received through the antenna 240A.

The mobile station is also assumed to include at least one local area receiver 270, such as one or more of a Bluetooth™ receiver, or a WLAN receiver, or an Ultra-Wide Band (UWB) receiver, that is coupled to a local area antenna 240B. While the local area receiver 270 and antenna 240B are shown as being used for RF reception, in other embodiments of this invention local area optical signals, such as infrared (IR) signals, may be received instead. The local antenna 240B receives, during mobility of the MS 100, low powered short range transmissions (e.g., a range typically of a few tens or hundred of meters, as opposed to the longer range (typically cellular) of antenna 240A) from a plurality of spatially distributed nodes 400 (node₁ . . . nodeₘ) associated typically with local entities and establishments, such as providers of information and/or goods and/or services (e.g., museums, libraries, restaurants, theaters, retail outlets, and so forth).

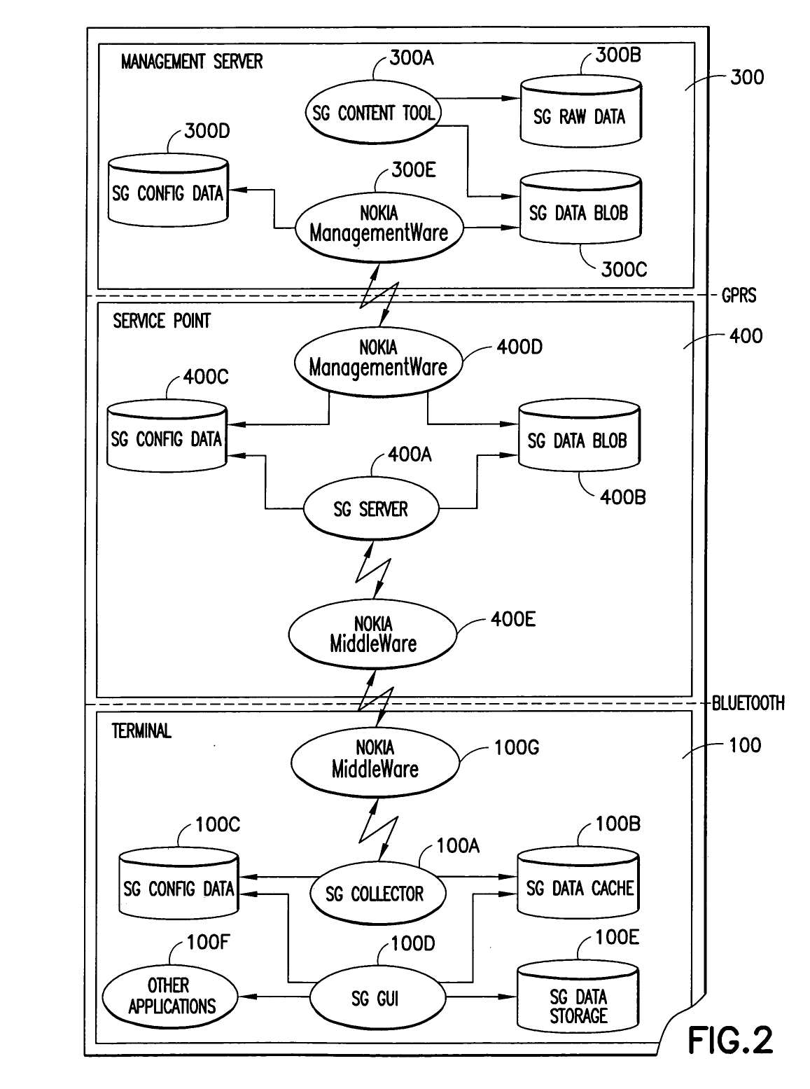

These nodes 400 may also be referred to as service points, as in FIG. 2. These local transmissions may also be referred to as beacons, and may be considered as channels through which local information, such as HTML pages, is received by the MS 100.

While the local area receiver 270 is shown having an output coupled to the DSP 180, this is not a limitation on the practice of this invention, as other circuitry may receive the output depending on the output format.

Referring to FIG. 2, there is shown an exemplary and non-limiting embodiment of a distributed system for providing local, short range service discovery to the MS 100. In FIG. 2 the system is referred to as the above-mentioned ServiceGuide™ (abbreviated SG) that is available from the assignee of this patent application. Reference can also be had to commonly assigned U.S. patent application Ser. No. 10/______ filed Mar. 17, 2004, entitled “System and Method for Remote Service Information”, by Sakari Kotola and Teppo Savinen, incorporated by reference herein in its entirety.

The SG system includes a network management server 300 that provides content creation tools for subscribers to the SG system. The management server 300 is comprised of a SG content tool 300A, SG raw data storage 300B, SG data blob storage 300C, SG configuration data storage 300D and an interface to a service point 400 through a management ware block 300E. A corresponding management ware block 400D is located in the service point 400, and the connection between them may be made via a cellular link (e.g., an IP/General Packet Radio Service (GPRS) link). The service point 400 may include a Bluetooth™ transceiver that is located at a service establishment, such as a restaurant, or a movie theater, or a retail clothing or other type of outlet. The service point 400 functions as a management client for the management server 300, and also includes a SG server 400A that communicates with the management ware 400D via SG data blob storage 400B and SG configuration data storage 400C, which are loaded from the corresponding management server storages 300C and 300D, respectively. Communication with the local receiver 270 of the MS 100 is made via (in this non-limiting embodiment) a Bluetooth middleware block 400E with a corresponding Bluetooth middleware block 100G in the MS 100. The memory 130 of the MS 100 is assumed to include program modules for implementing a SG collector function 100A coupled with a MS 100 SG data cache 100B, SG configuration data storage 100C, a SG graphical user interface (GUI) 100D that in turn communicates with SG data storage 100E and other applications 100F. An end result of this system is that the user of the MS 100 can have displayed on the display 140 various messages received from a plurality of service points 400 relating to various goods and services.

Referring to FIG. 3 there is shown on the display 140 a page 140A of the search engine 70 that provides, in a conventional manner, a field 142 for entering a search word or phrase and a button 144 for initiating the search based on the content of the field 142, under control of the a browser interface 130A and any required WWW search engine interface 130B.

Also shown in FIG. 3, in accordance with embodiments of this invention, is a local services user input area 146 for enabling the user to selectively one of request that: local services be included in the search engine 70A request (button 146A), or that no local services be included in the search engine 70A request (button 146B, i.e., the search is targeted at Internet pages only), or that only local services be included in the search request(button 146C, i.e., no search is done on Internet pages). When a local service is selected, the MS 100 makes use of the information obtained through the local area receiver 270 from one or more local service points 400.

If the user elects to make the search extend to local services in combination with the Internet search (button 146A is activated by the user), the search engine 70A, 130B, 130C may present the findings in separate lists, or in different tabs, or in any suitable manner for distinguishing the results of the wide area Internet search from the results of the local area search. In this manner the user can readily determine whether the results of the two searchers are related to local services.

The further aspect of the invention relates to the algorithm 130C and the operation thereof, which may combine the Internet search and the local search. As an example, assume that the user desires to locate a fine dining restaurant and uses a search term in field 142, e.g. “dinner restaurant”. The WWW search engine 70A is likely to produce many hits identifying restaurants over a large geographical area. However, the local search may produce only few hits, as not all local companies utilizing wireless local connectivity-based advertising would be restaurants.

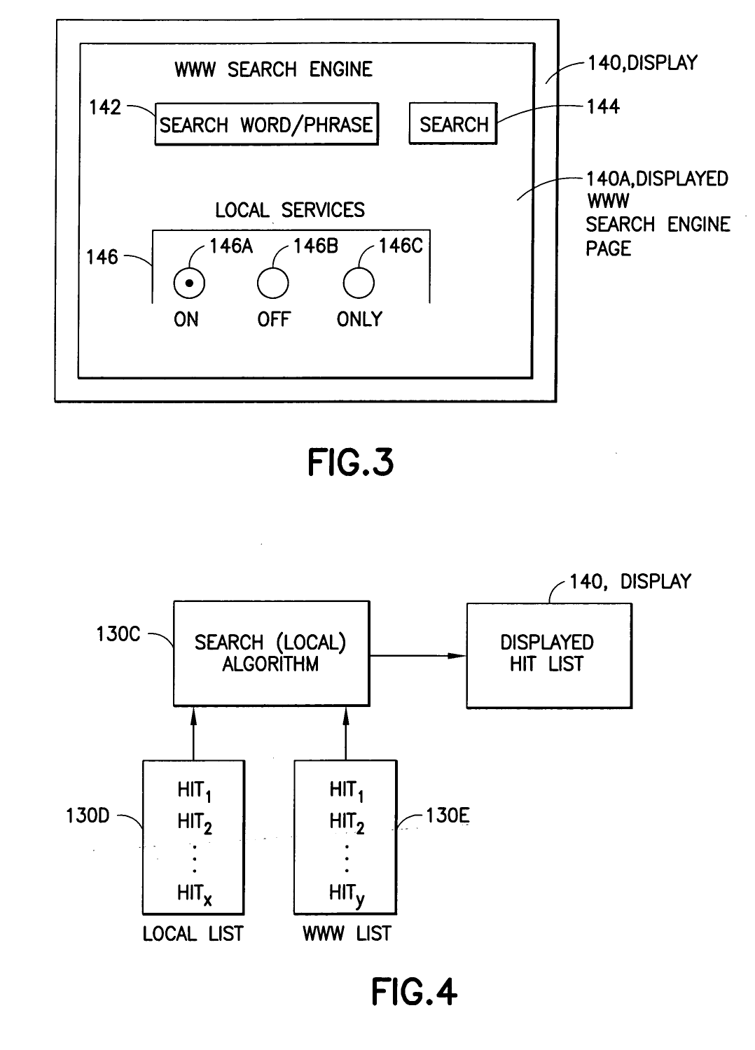

The search algorithm 130C may perform a cross-reference between the results of the two searches. Referring also to FIG. 4, the search algorithm 130C may use, as non-limiting examples, the list 130D of information from the local services, as received through the local receiver 270 from nodes 400, and may then compare this information, which may be referred to as “hits”, in the local list 130D (Hit₁-Hitₓ) with the hits in the WWW list 130E (Hit₁-Hit_{y}), where x is typically less than y, that are received through the receiver 220. The search algorithm 130C looks for a match, e.g., at least one hit in the local services list 130D has some number of words in common with a hit in the WWW result list 130E. In this case, the number of words in common can be defined as, as non-limiting examples, more than any other hit in the local service result list 130D, or more than an average number of hits in the local service list 130D. If the match is found, the local search algorithm 130C illustrates or highlights the hit in some manner, such as by placing it at the top of the hit list result displayed to the user on the display 140 and/or by displaying it in a different color.

It is preferred, but not required, that some part of the search result contain an address, as comparing address fields in hits in the WWW list 130E and in hits in the local services list 130D can be expected to produce the most reliable results for detecting matching or correlated hits. This can be done (partially at least) as in HTML, where there is an <address> tag feature. In the future, as systems such as the Semantic Web (see http://www.w3.org/2001/sw/) become more common, the result of the searching becomes even more reliable. See, for example, “Integrating Applications on the Semantic Web” (English version), James Hendler, Tim Berners-Lee and Eric Miller, Journal of the Institute of Electrical Engineers of Japan, Vol 122(10), October, 2002, p. 676-680, for a description of the utility of the Semantic Web.

The end result is that, instead of only obtaining the local advertisement (with typically limited information), the user is provided access as well to the WWW page of, or associated with, the nearby (local) restaurant. This local WWW page can be expected to typically contain more detailed information concerning the restaurant than would the local advertisement pushed through the Bluetooth/WLAN/UWB local link.

In preferred embodiments of this invention there is a combination of the “global” WWW search (which maybe a WWW page on the search engine 70A somewhere in the Internet 70) with the local search that utilizes the local Bluetooth/WLAN/UWB, or some other connection through the local receiver 270. To accomplish this task the local search algorithm preferably functions as a local “search client” of the MS 100, where the user inputs the search term(s), followed by the local search algorithm 130C functioning, possibly as a background task, to perform the local search and to also integrate the local search result (list 130D) with the result of the Internet search list 130E. Performing the local search can include examining the local list 130D to determine if any received bookmarks are relevant to the entered search word(s).

In practice, and assuming the presence of the local search engine 130D client in the MS 100, the user may define a preferred WWW search engine 70A for use, which the local client 130D connects to (and sends the search term(s) to) after the user has inputted the search term(s).

In a further embodiment of this invention a WWW page (in this case, a search engine 70A page) is modified so as to include information to inform the local browser embodied in the local search algorithm 130C to also utilize local connectivity for the search.

In still further embodiments of this invention there is provided an ability to distribute over the local link to the receiver 270 at least one predetermined search word set to the end users″device (e.g., to the MS 100). A search word set is selected such that it will, with high probability, produce Internet search results that contain some manageable number of hits, that are also contextually relevant to the end user. One non-limiting example is where the local system (e.g., the ServiceGuide™ system shown in FIG. 2) distributes links to information related to, for example, local restaurants. In addition to this mode of operation the ServiceGuide™ solution also transmits from a service point 400 to the MS 100 a Search Word Set that, when used as search words in an Internet search using the search engine 70A, it intended to produce a comprehensive (although possibly not exhaustive) list of, for example, restaurants in a local vicinity. Thus, those restaurants willing to directly advertise using, for example, the ServiceGuide™ system can effectively offer one-click-access to their Internet pages. The remainder of the restaurants instead rely on their information being found through the search with the provided Search Word Set.

As currently defined, the ServiceGuide™ bookmarks are defined with Extensible Markup Language (xml) as follows:

| | |
|---|---|
| Service Name | Service Category |
| Icon | Primary Link Type |
| Description | Link |
| Service Provider | Telephony (number) |
| | SMS (template and number) |
| | WAP (URL) |
| | HTML (URL) |
| Validity | |
| Download Time | |
| Download Place | |
| (URL) | |

Bookmarks are preferably filtered based on the receiving terminal type, network operator and language before downloading bookmarks to the MS 100.

In a presently preferred, but non-limiting embodiment this aspect of the invention is implemented by using the ServiceGuide™ bookmark structure, or one similar to or equivalent to the ServiceGuide™ bookmark structure, in the same manner as the current bookmarks, but while introducing a new bookmark type (e.g., Search Word Set).

FIG. 5 is a logic flow diagram that illustrates operations of pushing the Search Word Set to the MS 100 from a service point 400 (block 5A), the storage of the Search Word Set in the memory 130, such as in a Search Word Set buffer 130F (block 5B),and the use of the Search Word Set when launching the browser to perform the search using the WWW search engine 70A (block SC). More particularly, when the end user selects a Search Word bookmark from the ServiceGuide™ client user interface on the display 140, the (default) Internet browser 130A, 130B is launched with the (default) internet search engine 70A, and the search is carried out with the search words included in the selected Search Word bookmark. That is, the set of search words from the Search Word bookmark is effectively automatically inserted into the Search Word/Phrase field 142 (see FIG. 3) of the user default search engine 70A, and the search is launched with the predetermined Search Word Set that was received by the MS 100 via the local receiver 270.

The Search Word Set is preferably constructed so as to guarantee a hit for subscribers to the Search Word Set functionality of the local advertisement provider (such as the ServiceGuide™). For example, a restaurant's name, specialty and address may be included in the Search Word Set, thereby ensuring that the search engine 70A will return a hit, e.g.:

ABC Restaurant Seafood Main Street Anytown.

The foregoing search word set can be assumed to be contextually relevant to the user, as it includes spatial information (the address) that is in the vicinity of the MS 100, since it is received through the local receiver 270. After being received, the Search Word Set can be stored in the buffer 130F of the MS 100 until the user wishes to launch a search for a local restaurant, or more specifically for a local seafood restaurant, at which time the local search algorithm 130C retrieves the Search Word Set, such as by using one or more keywords (e.g., restaurant and/or seafood), and automatically inserts them into the search word/phrase field 142 of the Internet search engine 70A.

Further in accordance with embodiments of this invention, the operator is enabled to extend the customer base of the local advertising system (e.g., the ServiceGuide™ system) by creating, for example, two classes of advertising customers: a first group of customers having their own links (e.g., bookmark URLs) distributed to the end users through the local receiver 270, and a second group of customers that rely on the end user finding their information by use of the Internet search using the provided search word set, as in the foregoing example. Note that the probability of the second group of customers′information being found through the Internet 70A search with the provided search word set is high, since the search words are selected such that they produce the desired outcome. Thus, the probability of being located is significantly higher than if the end user devises a set of search words.

Based on the foregoing description, it can be appreciated that in accordance with embodiments of this invention the user need use only the one, familiar search engine 70A for both global WWW searches and local service searches.

The embodiments of the invention also enable a combination of local and global searches, enabling the user to obtain more, and higher quality, information than can be obtained using only the Internet search engine 70A, or the local search engine embodied in the algorithm 130C.

It should be appreciated that the embodiments of this invention also provide a technique for utilizing information created by other users in the Internet. For example, assume that a local beacon, e.g., a WLAN beacon, offers an HTML page for a certain restaurant advertising its quality, but the user may not know if the advertised information is correct. However, using the embodiments of this invention the user is enabled to utilize the local HTML page (or a portion of it, e.g., only the heading(s) or known information types, e.g. address, if available) as a search key for the WWW search engine 70A. In this manner the user is enabled to retrieve information concerning the restaurant that was created by other (impartial) users, therefore providing more objective information.

The embodiments of this invention also extend to cover those cases where the user does not input a search phrase. As a non-limiting example, the user may not be searching for anything specific, but desires to simply browse the local environment (via local area receiver 270) for interesting information. In so doing the user may enable only the local searcher 130C to detect any nearby beacons. The received local information may comprise, for example, HTML pages offered by the local beacons. Assume that the user then finds information of interest, e.g., a particular restaurant that is nearby. The user may then select to obtain more information about the restaurant, such as by performing a WWW search via browser 103A and search engine interface 130B, again by using the restaurant's local HTML page (or a selected part of it, as explained above) as a search key for the WWW search engine 70A.

Furthermore, the MS 100 may be configured to automatically perform a WWW search based on local information in the list 130D. As an example, via the UI 150 the user commands a search for anything nearby, and possibly to include the WWW in the search. The local searcher 30C then cooperates with the browser 103A and search engine interface 130B to generate search keys from any local information, and the WWW search is launched based on the generated search keys. The results may then be displayed to the user, such as in relevance order, so that the local page that provided the best hits is listed first, or in some other manner, such as by color coding. The ‘best’ hits may be determined in accordance with some user-defined or default logic, such as by how many common words appear in the local page(s) and in the page(s) found in the WWW search.

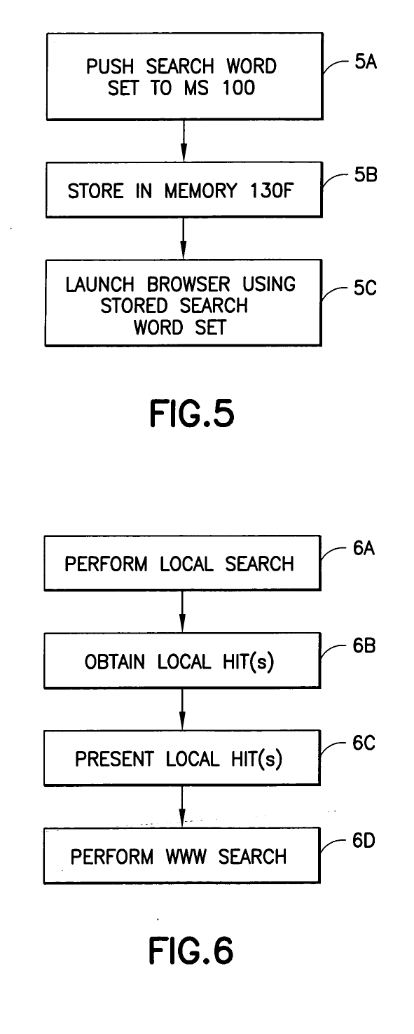

That is, and referring to the logic flow diagram of FIG. 6, the embodiments of this invention also pertain to a user interface wherein the user performs a local search (block 6A), obtains some number of local hits at (block 6B, which assumes the presence of at least one local beacon), and the local hits are presented as a list (or in some other suitable format, block 6C), where the list items may be, as non-limiting examples, the titles of the local HTML pages. The MS 100 subsequently performs a WWW search (block 6D), enabling the user to follow a local hit and determine what related WWW hits there are, if any. This mode of operation can be facilitated by making each local list 130D item a hyperlink to the list of WWW pages returned by the search engine 70A.

Note that in some embodiments of this invention the initiation of the WWW search may be automatically performed, without requiring explicit user input.

As was noted above, there may be several ways to obtain the local information. For example, at least one WLAN beacon and at least one Bluetooth beacon may serve the same local area, thereby providing multiple local channels.

Further, the results of the local search may be source(s) of goods and/or services, and also simply “information” that is received as a result of the local search. Information of any kind may be valuable for the end user, even if there is no further search initiated based on the results of a first search. The user can determine what to do with the retrieved information, for example, to use the search result as it is, or to initiate another search based on some criterion or criteria. Also, the information may have a semantic explanation, e.g. if the result is a noun, it may then contain a semantic explanation which binds the information to the situation or place, and which may be used in another search (e.g., an Internet search).

As was noted previously, the embodiments of this invention also provide the capability of distributing predefined search word sets to the end users′devices, such as the MS 100. The search word set is selected such that it will, with high probability, produce Internet search results that contain a manageable number of hits that are also contextually relevant to the user.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. As but some examples, the use of other similar or equivalent types of local connectivity interfaces and sub-systems may be attempted by those skilled in the art. However, all such and similar modifications of the teachings of this invention will still fall within the scope of the embodiments of this invention.

It is further noted that the logic flow diagrams of FIGS. 5 and 6 may also be viewed as block diagrams of logic elements, units and circuits coupled together to perform the desired task(s).

Furthermore, some of the features of the preferred embodiments of this invention maybe used to advantage without the corresponding use of other features. As such, the foregoing description should be considered as merely illustrative of the principles, teachings and embodiments of this invention, and not in limitation thereof.

What is claimed is:

1. A method to conduct a search for information in a network, comprising:
operating a user interface of a device to initiate the sending of a search request via a first channel; and
indicating via the user interface selectively whether information from at least one local source received via at least one second channel is to be included as at least a part of the search.

2. A method as in claim 1, where the first channel comprises a wireless cellular communication channel, and where the at least one second channel comprises a short range channel for receiving the information from at least one local short range transmitter.

3. A method as in claim 1, where the first channel comprises a wireless cellular communication channel, and where the at least one second channel comprises a short range channel for receiving the information from at least one Bluetooth transmitter.

4. A method as in claim 1, where the first channel comprises a wireless cellular communication channel, and where the at least one second channel comprises a short range channel for receiving the information from at least one WLAN transmitter.

5. A method as in claim 1, where the first channel comprises a wireless cellular communication channel, and where the at least one second channel comprises a short range channel for receiving the information from at least one UWB transmitter.

6. A method as in claim 1, where the received information comprises at least an identification of a source of goods or services.

7. A method as in claim 1, where the received information comprises at least one of a URL associated with a source of goods or services, or a HTML page associated with a source of goods or services.

8. A method as in claim 1, where the received information comprises at least a predetermined Search Word Set that is incorporated into the search request.

9. A method as in claim 1, further comprising comparing hits received in response to sending the search request with stored information received via the at least one second channel to determine if any the stored information is relevant to the received hits, and reporting relevant stored information to a user.

10. A method as in claim 1, further comprising comparing search result information received in response to sending the search request with stored information received via the at least one second channel to determine if any the stored information is relevant to the received search result information; augmenting at least some of the received search result information with relevant stored information and reporting the augmented received search result information to a user.

11. A device comprising a user interface, a first interface to a first channel, at least one second interface to at least one second channel, and a controller coupled to the user interface and to the first and second interfaces, said controller operable to conduct a search for information in a network in response to input received from said user interface by initiating the sending of a search request via the first channel and further in response to input received from said user interface to determine whether received information from at least one local source via said at least one second channel is to be included as at least a part of the search.

12. A device as in claim 11, where the first channel comprises a wireless cellular communication channel, and where the at least one second channel comprises a short range channel for receiving the information from at least one local short range transmitter.

13. A device as in claim 11, where the first channel comprises a wireless cellular communication channel, and where the at least one second channel comprises a short range channel for receiving the information from at least one Bluetooth transmitter.

14. A device as in claim 11, where the first channel comprises a wireless cellular communication channel, and where the at least one second channel comprises a short range channel for receiving the information from at least one WLAN transmitter.

15. A device as in claim 11, where the first channel comprises a wireless cellular communication channel, and where the at least one second channel comprises a short range channel for receiving the information from at least one UWB transmitter.

16. A device as in claim 11, where the received information comprises at least an identification of a source of goods or services.

17. A device as in claim 11, where the received information comprises at least one of a URL associated with a source of goods or services, or a HTML page associated with a source of goods or services.

18. A device as in claim 11, where the received information comprises at least a predetermined Search Word Set that is incorporated into the search request.

19. A device as in claim 11, further comprising a memory coupled to said controller for storing information received via the at least one second channel during mobility of said device, said controller further operative to compare hits received in response to sending the search request with the stored information to determine if any the stored information is relevant to the received hits, and to report relevant stored information to a user via said user interface.

20. A device as in claim 11, further comprising a memory coupled to said controller for storing information received via the at least one second channel during mobility of said device, said controller further operative to determine if any the stored information is relevant to the received search result information and, if so, to augment at least some of the received search result information with relevant stored information and to report the augmented received search result information to a user via said user interface.

21. A computer program product comprising computer executable instructions stored in a computer readable medium for directing a computer embodied in a mobile device to conduct a search for information in a network, comprising operations of:
operating a user interface of the device to initiate the sending of a search request via a first channel; and
indicating via the user interface selectively whether received information from at least one local source via at least one second channel is to be included as at least a part of the search.

22. A computer program product as in claim 21, where the first channel comprises a wireless cellular communication channel, and where the second channel comprises a short range channel for receiving the information from at least one local short range transmitter during mobility of said device.

23. A computer program product as in claim 21, where the first channel comprises a wireless cellular communication channel, and where the second channel comprises a short range channel for receiving the information from at least one of a Bluetooth transmitter, a WLAN transmitter and a UWB transmitter.

24. A computer program product as in claim 21, where the received information comprises at least an identification of a source of goods or services.

25. A computer program product as in claim 21, where the received information comprises at least a URL associated with a source of goods or services.

26. A computer program product as in claim 21, where the received information comprises at least a predetermined Search Word Set that is incorporated into the search request.

27. A computer program product as in claim 21, further comprising operations of comparing hits received in response to sending the search request with stored information received via the second channel to determine if any the stored information is relevant to the received hits, and reporting relevant stored information to a user.

28. A computer program product as in claim 21, further comprising operations of comparing search result information received in response to sending the search request with stored information received via the second channel to determine if any the stored information is relevant to the received search result information; augmenting at least some of the received search result information with relevant stored information and reporting the augmented received search result information to a user.

29. A device comprising user interface means, first interface means for coupling to a first wireless channel, second interface means for coupling to at least one second wireless channel, and control means coupled to the user interface means and to the first and second interface means for conducting a search for information in a network in response to input received from said user interface means, said control means for initiating the sending of a search request via the first channel and, responsive to input received from said user interface means, to determine whether received information from at least one local source via said second channel is to be included as at least a part of the search.

30. A device as in claim 29, where the received information comprises at least a predetermined Search Word Set that is incorporated by said control means into the search request.

31. A device as in claim 29, further comprising memory means coupled to said control means for storing information received via the second channel during mobility of said device, said control means further operative for comparing hits received in response to sending the search request with the stored information for determining if any the stored information is relevant to the received hits, and for reporting relevant stored information to a user via said user interface means.

32. A device as in claim 29, further comprising memory means coupled to said control means for storing information received via the second channel during mobility of said device, said control means further operative for determining if any the stored information is relevant to the received search result information and, if so, for augmenting at least some of the received search result information with relevant stored information and for reporting the augmented received search result information to a user via said user interface means.

33. A node of a communication system comprising a transmitter for communicating to a receiver of a device during mobility of the device, said node operable for transmitting a predetermined search word set to the receiver for use by the device for composing a search request to a search engine.

34. A method to conduct a search for information, comprising:
receiving information from at least one local source via at least one local wireless beacon;
storing received information; and
selectively using at least some of the stored information when initiating a search via a wireless link to the Internet.

35. A method as in claim 34, where initiating occurs in response to input from a user.

36. A method as in claim 34, where initiating occurs automatically without input from a user.

37. A method as in claim 34, where the at least one local wireless beacon comprises a transmission from at least one of a Bluetooth transmitter, a WLAN transmitter and a UWB transmitter.

38. A method as in claim 34, where selectively using uses at least a portion of an HTML page.

39. A method as in claim 34, where storing occurs in a memory of a wireless communications device.

40. A wireless communications device, comprising:
means for receiving information from at least one local source via at least one local wireless beacon;
means for storing received information; and
means for selectively using at least some of the stored information to initiate a search via a wireless link to the Internet.

41. A wireless communications device as in claim 40, where initiating the search occurs in response to input from a user interface means.

42. A wireless communications device as in claim 40, where initiating the search occurs automatically.

43. A wireless communications device as in claim 40, where said means for receiving is responsive to a transmission from at least one of a Bluetooth transmitter, a WLAN transmitter and a UWB transmitter.

44. A method as in claim 34, where said means for selectively using uses at least a portion of an HTML page.

45. A computer program embodied in a computer readable medium for execution by a processor of a mobile communication device, the execution comprising operations of:
when the mobile communication device is located in a certain geographical area, receiving a transmission from at least one local source via at least one local wireless beacon;
storing information conveyed by the received transmission; and
formulating an Internet search request for transmission from the mobile communication device, the Internet search request being formulated at least in part from the stored information so as to be pertinent to the certain geographical area.

46. A computer program as in claim 45, where formulating the Internet search request comprises receiving input from a user of the mobile communication device via a user interface of the mobile communication device.

47. A computer program as in claim 45, where formulating the Internet search request is performed by the processor without input from a user.
